(19) United States
(12) Patent Application Publication
(10) Pub. No.: US 2007/0106935 A1
(43) Pub. Date: May 10, 2007

(54) Apparatus and method for implementing flexible page layout

(75) Inventors: Yi Su, Guangdong Province (CN); Jianjun Liu, Guangdong Province (CN); Yongsheng Guo, Guangdong Province (CN); Zhixiong Zhang, Guangdong Province (CN)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: HUAWEI TECHNOLOGIES CO., LTD., Shenzhen (CN)

(21) Appl. No.: 11/580,209

(22) Filed: Oct. 12, 2006

(30) Foreign Application Priority Data
Oct. 14, 2005 (CN) 200510112922.2

(51) Int. Cl. G06F 17/00

(52) U.S. Cl. 715/517; 715/520

(57) ABSTRACT

An apparatus and a method for implementing a flexible page layout. The apparatus includes: a page presentation unit, for providing at least one presentation mode of the page layout; a page control unit connected with the page presentation unit, for selecting resources supported by the user terminal, loading the resources to the page presentation unit, and generating a display page for providing to the user. The method includes: providing at least one presentation mode of the page layout; selecting resources supported by the user terminal, loading the resources according to the at least one presentation mode, and generating a display page. According to the invention, page layout diversification may be realized and various types of contents may be loaded in a page flexibly.

### CROSS-REFERENCE TO RELATED APPLICATIONS

This application claims priority to Chinese Patent Application priority number 200510112922.2, filed Oct. 14, 2005, the disclosures of which are hereby incorporated herein by reference.

### FIELD OF THE INVENTION

The present invention relates to the field of computer application technology, in particular, to an apparatus and a method for implementing a flexible page layout.

### BACKGROUND OF THE INVENTION

A Portal system is an information-cooperation network portal focused on users and is a Web-based application system. It can integrate various resources of an enterprise so as to make good use of such resources, and at the same time, protect users from being submerged in abundant information provided by the network. As a result, a user may easily find needed information and make use of the related functions. Such an information system has been widely used and has become an important means for enterprise information resource integration. A Portal system provides the features of personalization, single logging-on and content aggregation from different sources.

The concept of “portlet” has been introduced to realize the customizability of a Portal system. A portlet is a pluggable user interface component, which is usually implemented by the Java technologies based on Web components. A comprehensive management is performed via a Portlet Container, wherein the Portlet Container processes the request sent from a user and returns a page dynamically, and finally the Portal system assembles and returns a full page to the user.

The layout of a Portal system determines the arrangement pattern of a user page and the page structure that can be used by a user. It is one of the most important parts of the personalization characteristics of the Portal system. The layout module is also responsible for providing suitable layouts for different devices, so as to meet the requirement of a device with a small screen, such as a Personal Digital Assistant (PDA), etc.

A Portal system may also realize the assignability of content editing through the layout, that is, page content editing may be managed in a personalized way by arranging different managing users for different regions of a page and assigning different operation rights.

At present, there may be many problems with the layout of a Portal system:

because the logic control codes and the template of the layout are bound together, it is difficult to modify or secondarily develop the layout template;

the layout format of the layout template is relatively simple, for example, having only a few rows or columns;

only contents packaged by a portlet can be loaded in the layout.

No good method can be found in the prior art to solve the above problems.

### SUMMARY OF THE INVENTION

Embodiments of the present invention provide an apparatus and a method for implementing a flexible page layout, by which diversification of page layouts may be realized and various types of contents may be flexibly loaded in a page.

According to an embodiment of the invention, an apparatus for implementing a flexible page layout includes:

a page presentation unit, for providing at least one presentation mode of the page layout; and

a page control unit connected with the page presentation unit, for selecting resources supported by a user terminal, loading the resources to the page presentation unit, and generating a display page.

The page presentation unit includes:

a layout presentation template, for providing the at least one presentation mode of the page layout to the user terminal by means of a template; and

a template converter connected with the layout presentation template, for converting the layout presentation template into a file recognizable by the user terminal.

The page control unit includes:

a logic control module, for selecting the resources supported by the user terminal, loading the resources in the file converted from the layout presentation template and recognizable by the user terminal, and generating the display page; and

a resource recognition base component connected with the logic control module, for storing the resources which are supported by the user terminal and displayable on a page.

The resources include, but not limited to, portlet, picture, file and Flash.

According to an embodiment of the invention, a method for implementing a flexible page layout includes:

providing at least one presentation mode of the page layout; and

selecting resources supported by a user terminal, loading the resources according to the at least one presentation mode, and generating a display page.

Preferably, the at least one presentation mode of the page layout is provided by various layout presentation templates.

More suitably, the method further includes:

Associating the user terminal with a resource recognition base component according to the type of the user terminal, wherein the resource recognition base component contains various displayable data types supported by the user terminal, including, but not limited to, portlet, picture, file and Flash.

The layout presentation template provides a corresponding interface externally, for converting the template file into a file recognizable by the user terminal.

Each region of the layout presentation template may be an available region to be filled with various resources, and the method further includes:

selecting a layout presentation template, and loading the resources supported by the user terminal in the layout presentation template.

More suitably, the method further includes:

selecting the resources from the resource recognition base component, recognizing the resources and generating corresponding presentation codes;

converting the layout presentation template to a file recognizable by the user terminal according to the interface provided by the selected layout presentation template externally, loading the presentation codes in the file, and generating the display page.

In comparison with the prior art, embodiments of the invention can solve the problem that the page layout format is too simple by separating the layout control portion and the layout presentation portion of a layout, and can design diverse layout presentation templates as required and extend the templates continuously by template nesting, so as to implement a complicated page layout.

In an embodiment of the invention, the page layout can be modified flexibly. With the technical solution of the invention, to modify a layout, it only needs to modify a template corresponding to the layout or convert the template into another template.

In an embodiment of the invention, automatic recognition and management of resources may be realized, and various types of contents may be loaded in a page flexibly. In the layout, nearly all the contents displayable on a web page can be recognized without converting these contents into Portlets.

### BRIEF DESCRIPTION OF THE DRAWINGS

FIG. 1 shows a structure diagram of an apparatus according to an embodiment of the invention;

FIG. 2 shows a process flowchart of a method for implementing a flexible layout according to an embodiment of the invention;

FIG. 3a and FIG. 3b show, respectively, a schematic diagram illustrating region distribution of a layout presentation template according to an embodiment of the invention;

FIG. 4 shows a schematic diagram of implementing a complicated layout by element mergence on tables of a layout presentation template according to an embodiment of the invention;

FIG. 5 shows a schematic diagram of implementing element partition on tables of a layout presentation template according to an embodiment of the invention; and

FIG. 6 shows a schematic diagram of implementing table nesting on tables of a layout presentation template according to an embodiment of the invention.

### DETAILED DESCRIPTION OF THE EMBODIMENTS

Embodiments of the invention provide an apparatus and a method for implementing a flexible page layout, wherein the layout control portion and the layout presentation portion are separated, the layout presentation portion is implemented by a layout presentation template, and various complicated layouts are implemented in the form of tables.

To further understand the principle, characteristics and advantages of the invention, embodiments of the invention will now be described in detail in conjunction with the drawings.

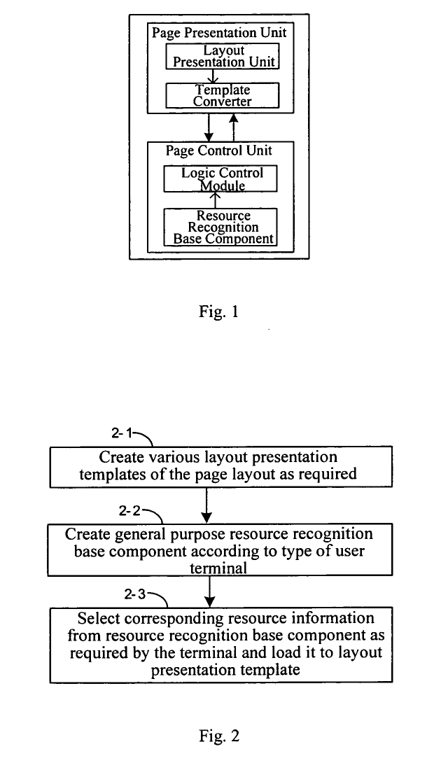

FIG. 1 shows a structure diagram of the apparatus according to an embodiment of the invention, which includes:

a page presentation unit, for providing various presentation modes of a page layout to a user terminal, the page presentation unit including a layout presentation template and a template converter, wherein:

the layout presentation template is used for providing the various presentation modes of the page layout to the user terminal by means of a template; and

the template converter is used for converting the layout presentation template into a file recognizable by the user terminal; and

a page control unit, for selecting resources supported by the user terminal as required and loading the resources into the page presentation unit, thus generating a display page for providing to the user terminal, the page control unit including a logic control module and a resource recognition base component, wherein:

the logic control module is used for selecting the resources supported by the user terminal and loading the resources into the layout presentation template, thus generating the display page for providing to the user terminal; and

the resource recognition base component is used for storing various data types which are supported by the user terminal and displayable on a page, including, but not limited to, portlet, picture, file and Flash.

Based on the above apparatus, a specific process flow of the method for implementing a flexible page layout according to an embodiment of the invention is illustrated in FIG. 2.

In step 2-1, various layout presentation templates of the page layout are created as required.

In an embodiment of the invention, the layout presentation portion of the layout is implemented by a layout presentation template. Therefore, the various layout presentation templates of the layout should be created first according to different requirements of a user.

In an embodiment of the invention, the layout presentation template supports a descriptive language. As a result, a developer may select a familiar language, such as Hyper Text Markup Language (HTML), to develop a template file for the layout presentation template.

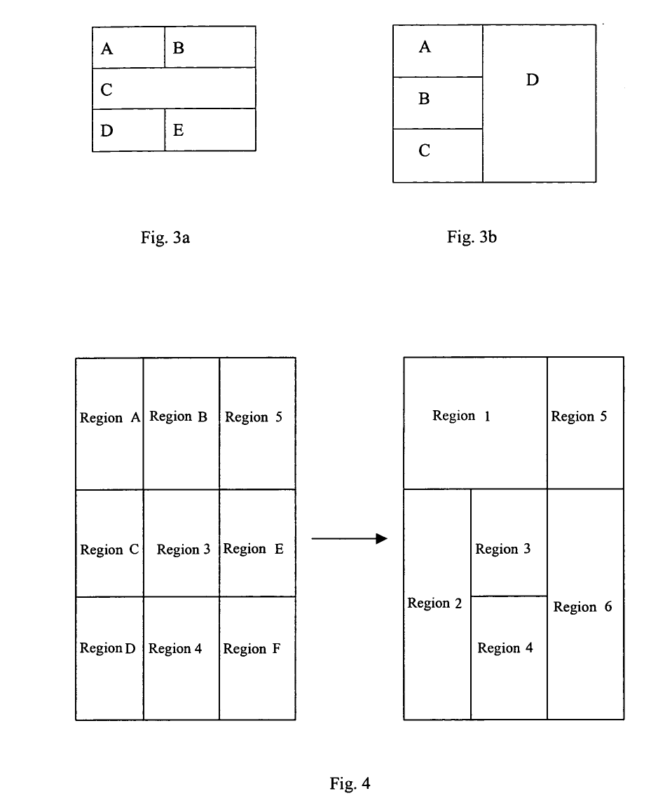

As shown in FIG. 3a, a layout presentation template is defined as a layout with five regions A, B, C, D and E.

As shown in FIG. 3b, a layout presentation template includes four regions A, B, C and D, each of which may be filled with one or more types of contents (portlets or other resources).

For example, the template file of the layout shown in FIG. 3a may be defined in HTML as follows:

<table>
<tr>
<td><portal:resource id=”A”></td>
<td><portal:resource id=”B”></td>
</tr>
<tr>
<td colspan=”2”><portal:resource id=”C”></td>
<tr>
<tr>
<td><portal:resource id=”D”></td>
<td><portal:resource id=”E”></td>
</tr>
</table>

In a specific solution, various layout presentation templates may be written in the form of tables. Because the layout presentation template is independent of the layout control module, various modifications can be made to the layout presentation template so as to implement various complicated layouts. Further, different requirements of users on a layout can be fulfilled directly through the layout function of the layout without creating skeleton files individually.

The main principle is as follows: a basic layout presentation template is written in the form of tables, each table representing a certain region of the layout. Each table may also be filled with contents through a Markup Language, such as for displaying a picture or characters, etc. As shown in the left layout of FIG. 4, the partition of nine layout regions is implemented by nine tables. Then a complicated layout may be implemented by table nesting, element partition or element mergence, or the combination thereof. As a result, the limitation on rows and columns may be eliminated. A complicated layout may be implemented by the above format processing on a table of a layout presentation template.

FIG. 4 shows a schematic diagram of element mergence on tables of a layout presentation template according to an embodiment of the invention. As shown in FIG. 4, region 1 is a mergence of region A and region B, region 2 is a mergence of region C and region D, and region 6 is a mergence of region E and region F.

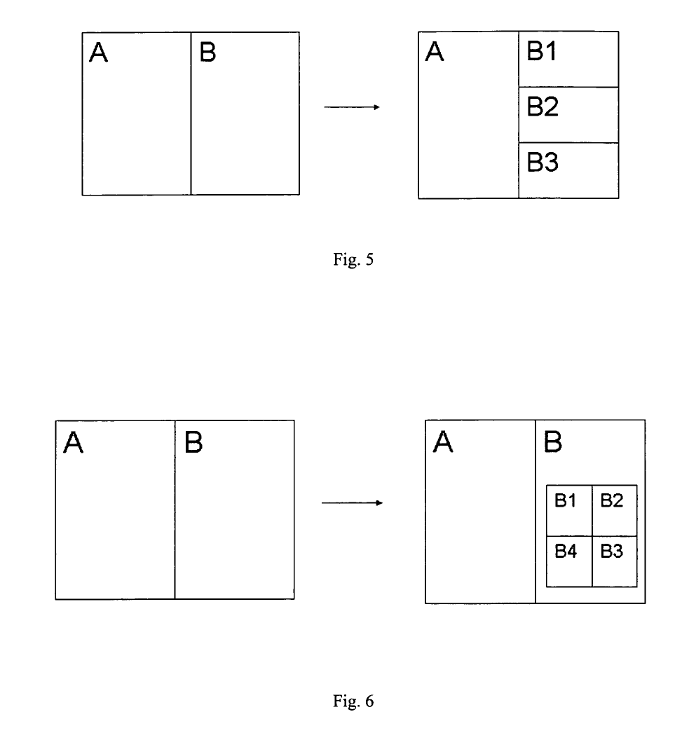

FIG. 5 shows a schematic diagram of element partition on tables of a layout presentation template according to an embodiment of the invention. As shown in FIG. 5, region B is partitioned into three sub-regions B1, B2 and B3.

FIG. 6 shows a schematic diagram of table nesting on tables of a layout presentation template according to an embodiment of the invention. As shown in FIG. 6, the layout descriptions of four regions B1, B2, B3 and B4 are used in a nested way in region B.

In an embodiment of the invention, the layout presentation template may also be used as a resource, that is, template nesting may be achieved. By nesting a template into any of other templates, multiple functions of a layout may be achieved more effectively.

In an embodiment of the invention, each region of the layout presentation template may be used as an available region and have a unique ID, and any type of resources may be filled therein. The ID information of a region may be used in a layout to read the resource set of the region. At the same time, the operation right, the filled contents and the editability of the region may be controlled.

In an embodiment of the invention, the layout presentation template needs to provide a corresponding interface externally, by which the layout presentation template file may be converted into a file recognizable by various terminals.

In step 2-2, a general purpose resource recognition base component is created according to the type of the user terminal.

In an embodiment of the invention, a corresponding template is invoked to implement the layout according to the type of the user terminal. For example, if the user terminal supports WML, a template described in WML may be invoked to implement the layout, and it may be provided that the added contents must support WML. Accordingly, the data types supported by the user terminal may be collected and the corresponding presentation labels or codes may be stored, so that a general purpose resource recognition base component may be created. Because the layout control module and the layout presentation template of the layout are separated, all the data types which are displayable on a web page and supported by the user terminal can be processed as resources. For example, a portlet, a picture, a file, a Flash, etc. may all serve as resources and be stored in the resource recognition base component.

By use of the above resource recognition base component, a dynamic management of user resource types can be realized. The user resource types may be added by adding new resources to the resource recognition base component.

In step 2-3, corresponding resource information is selected from the resource recognition base component as required by the user terminal and is loaded to the layout presentation template.

In an embodiment of the invention, the layout control portion of the layout includes a logic control module and a resource recognition base component.

The logic control module may search for corresponding resources in the resource recognition base component as required by the user terminal, and then recognize the data types of the resources automatically and generate corresponding presentation codes.

The template converter converts the selected layout presentation template into a file recognizable by a user terminal. The logic control module combines the generated presentation codes with the file and generates a full page for displaying to the user.

Additional advantages and modifications will readily occur to those skilled in the art. Therefore, the invention in its broader aspects is not limited to the specific details and representative embodiments shown and described herein. Accordingly, various variations and modifications may be made without departing from the spirit or scope of the invention as defined by the appended claims and their equivalents.

What is claimed is:

1. An apparatus for implementing a flexible page layout, comprising:
a page presentation unit, for providing at least one presentation mode of the page layout; and
a page control unit connected with the page presentation unit, for selecting resources supported by a user terminal, loading the resources to the page presentation unit, and generating a display page.

2. The apparatus according to claim 1, wherein the page presentation unit comprises:
a layout presentation template, for providing the at least one presentation mode of the page layout to the user terminal by means of templates; and
a template converter connected with the layout presentation template, for converting the layout presentation template to a file recognizable by the user terminal.

3. The apparatus according to claim 2, wherein the page control unit comprises:
a logic control module, for selecting the resources supported by the user terminal, loading the resources in the file converted from the layout presentation template and recognizable by the user terminal, and generating the display page; and
a resource recognition base component connected with the logic control module, for storing the resources which are supported by the user terminal and displayable on a page.

4. The apparatus according to claim 3, wherein the resources comprise portlet, picture, file and Flash.

5. A method for implementing a flexible page layout, comprising:
providing at least one presentation mode of the page layout; and
selecting resources supported by a user terminal, loading the resources according to the at least one presentation mode, and generating a display page.

6. The method according to claim 5, wherein the at least one presentation mode of the page layout is provided by various layout presentation templates.

7. The method according to claim 5, further comprising:
associating the user terminal with a resource recognition base component according to the type of the user terminal, wherein the resource recognition base component contains various displayable data types supported by the user terminal.

8. The method according to claim 7, wherein the various displayable data types comprises portlet, picture, file and Flash.

9. The method according to claim 6, wherein the layout presentation template provides a corresponding interface externally, for converting the template file to a file recognizable by the user terminal.

10. The method according to claim 6, wherein each region of the layout presentation template is an available region to be filled with various resources, and the method further comprises:
selecting a layout presentation template as required, and loading the resources supported by the user terminal in the layout presentation template.

11. The method for according to claim 7, further comprising:
selecting the resources from the resource recognition base component, recognizing the resources and generating corresponding presentation codes; and
converting the layout presentation template to a file recognizable by the user terminal according to an interface provided by the selected layout presentation template externally, loading the presentation codes in the file, and generating the display page.

12. The method according to claim 8, further comprising:
selecting the resources from the resource recognition base component and recognizing the resources to generate corresponding presentation codes; and
converting the layout presentation template to a file recognizable by the user terminal according to an interface provided by the selected layout presentation template externally, loading the presentation codes in the file, and generating the display page.
